(19) United States
(12) Patent Application Publication
(10) Pub. No.: US 2009/0008890 A1
(43) Pub. Date: Jan. 8, 2009

(54) Suspension system for an all-terrain vehicle

(76) Inventor: James R. Woodford, San Diego, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/157,771

(22) Filed: Jun. 13, 2008

Related U.S. Application Data
(60) Provisional application No. 60/934,539, filed on Jun. 15, 2007.
(60) Provisional application No. 60/934,529, filed on Jun. 13, 2007.

(51) Int. Cl. B60G 1/00

(52) U.S. Cl. 280/124.113; 280/124.11

(57) ABSTRACT

A steerable suspension for an all terrain vehicle providing increased travel for the wheels for enhanced shock absorption by springs and shock absorbers. Pivotal juxtaposed engagement of the A-frame supports for the front of the suspension on sides of the vehicle frame opposite from the wheels supported provides the increased travel. A pivoting spindle support maintains the wheels parallel while pivoting rear supports to the A-frames are axially positioned relative to the wheel to increase strength.

This application is a Continuation-in-Part and claims priority to, U.S. Provisional Patent Application Ser. No. 60/934,529, filed Jun. 13, 2007, which is incorporated herein in its entirety by reference. The disclosed system and method relate generally to vehicle suspension systems. More particularly, the disclosed device relates to a long-travel suspension system for an all-terrain vehicle which provides substantially increased travel for the wheel hubs to provide for increased shock absorption, by employing a unique off-center engagement of pivoting A-frames to the frame of the vehicle.

### FIELD OF THE INVENTION

### Background of the Invention

The term “All-Terrain Vehicle” or ATV is conventionally used as a description for any of a number of small open motorized buggies and tricycles designed for off-road use. Generally, an ATV is a vehicle that travels on low pressure tires, with a seat engaged to a frame. The operator straddles the seat and controls the vehicle with gas and brake controls mounted on the handlebars which are also employed for steering the vehicle. Most modern ATV vehicles employ four such tires for increased stability.

In use, the rider sits on the frame-engaged seat and operates an ATV much like a motorcycle. Because it employs four wheels, the ATV has much more stability at slow speeds than the two-wheel motorcycle. However, having a frame and four large wheels with heavy tires also imparts much more weight to an ATV than a motorcycle. The mass of the tires and wheels will inherently communicate more force to the vehicle suspension when traversing bumps and landing from jumps.

With the constant evolution of small vehicle engines, modern ATVs have sufficient horsepower to reach very high speeds even with the extra weight afforded by four large tires and the supporting frame and suspension. During slow travel, suspension is not generally a problem for most riders. However, as speed increases, a high-powered ATV can reach sufficient speeds to leave the ground when traveling over rises and bumps in the roadway. While leaving the ground is not generally a problem for most riders, landing a large and heavy ATV with large heavy tires and wheels can be fraught with peril.

Higher speeds obtainable by such ATVs yield higher elevations once the vehicle leaves the ground. Since force imparted to the suspension will be equivalent to the mass of the airborne wheel times acceleration, an ATV reaching heights above the ground will greatly increase the force upon the ATV frame and especially upon the suspension when landing.

Thus, an ATV hitting the ground at high speed subsequent to launching over a bump or ramp can subject the frame and suspension to extreme forces. The rider, sitting on the seat or even standing on foot pegs, is subjected to the same forces. Should the suspension which is intended to dampen the force of landing be inadequate to the task, the rider can suffer injury or loss of control of the vehicle subsequent to a hard landing.

In order to help dampen the force imparted to the rider and vehicle frame, modern ATVs employ some of the shock-absorbing components of cars and motorcycles. In the suspension of an ATV springs are employed to absorb force of impacts on the vehicle and rider when landing from an airborne status. During a landing, the force of weight of the ATV is imparted to the landing wheel and tire which are engaged to a moving suspension component engaged to the wheel axle. The spring compresses and employs some of the force to do the work of compressing the spring.

In combination with the spring are hydraulic dampeners also known as shock absorbers. The compression of the spring from the force of the vehicle hitting the ground and moving the suspension to accomplish the compression of the spring also stores energy in the spring. The shock absorbers engaged to the traveling suspension act to absorb or dampen the re-extension of the spring to its original length, and the force stored in the compressed spring is redirected to pump hydraulic fluid in the shock absorber.

By absorbing the forces of landing the ATV with a spring and then redirecting those stored forces in the compressed spring to pump fluid, much of the force of impact of a landing ATV can be shielded from the rider. This has a twofold effect of keeping the rider from suffering impact injuries on landing and keeping the vehicle suspension from failing under heavy stresses.

Suspensions on conventional ATVs generally employ an A-frame or similar structure in a pivoted engagement to the frame at the center of the vehicle at two points. The opposite end of the A-frame from the two point engagement to the frame is engaged to a wheel hub, and also may have a braking system engaged thereon. Springs are engaged between the frame of the vehicle and the rotating A-frame to absorb shock forces when an airborne vehicle lands and pivots the A-frame in its engagement with the frame. The shock absorbers, as noted, are at first compressed by the action of the A-frame pivoting and then are expanded by the force of compressed springs re-elongating. During this expansion action, internal hydraulics of the shock acts to convert the force of impact to do the work of pumping fluid, thereby shielding the rider and vehicle from the full force of impact.

There is a limit to the amount of force the spring can absorb and store to shield the rider during landings. The distance of travel of the distal end of the A-frame, opposite its two-point engagement to the vehicle frame, determines the distance of compression a spring can absorb and the distance of compression of the shock absorber on landing. The shorter this travel distance, the less shock absorption the spring and shock of the ATV suspension can provide to the vehicle and rider.

Modern ATVs are severely limited in travel of the A-frame thus severely limiting shock absorption. This is especially true with the front two wheels. Since these two wheels are employed to steer the vehicle when the handle bars are turned, the wheel hub engaged to the handlebars must pivot on the distal ends of the A-frame. Steering linkage communicates turning to both wheel hubs to turn the tires and thus redirect the path of the vehicle. This is quite unlike modern motocross motorcycles which generally are turned by the rider leaning on the motorcycle which causes a turn. Instead, ATVs having four wheels must be turned by redirecting the tires on the front of the vehicle in the direction desired.

Because steering linkage is employed separately of the A-frames on ATVs, modern ATVs have maintained the pivot points for each front A-frame engaged to the vehicle frame on the side of the vehicle frame on which the wheel being turned is located. This arrangement simplifies the steering linkage and shortens the rods employed to link the wheel hub to the handlebar.

However, this conventional arrangement also severely limits the amount of travel the distal end of the A-frame and thus the travel of the heavy off road tires and the amount of compression the spring and shock can absorb on a landing. While this is not generally an issue for most occasional or recreational riders, for professional and other highly skilled riders this arrangement severely limits their ability to ride ATVs at higher speeds. Because highly skilled riders travel at higher speeds, the vehicles will rise higher into the air when launched to become airborne such as when driving up a ramp or over a bump. The higher elevation reached by the vehicle will result in severe impact forces on landing which can injure the rider or damage the vehicle. Conventional ATV suspensions with their engagement of the A-Frame centered or on the side of the vehicle of the hub cannot provide sufficient travel to dampen the vehicle and rider on landing.

As such, there exists an unmet need for an ATV front suspension that will accommodate the need for more travel of the distal end of the A-frame which provides the mount for the wheel hub. Such a device should provide for a maximum travel upward and thus maximize shock absorption potential on landing. However, because the front wheels also steer, such a device should still allow for easy steering in a conventional fashion by turning handlebars.

### SUMMARY OF THE INVENTION

The device as herein disclosed and described provides a highly improved front suspension for an ATV on which a rider straddles the frame-mounted seat and turns the front wheels with a handlebar. The disclosed device provides substantially increased travel of the wheel hub on the distal end of the frame engaged A-frame, to allow for substantially increased shock absorption by the springs and shock absorbers on landing.

As depicted, the front suspension features two upper and two lower A-frames all of which pivot on an engagement with the vehicle frame on an engagement end. Opposite the two point pivoting engagement with the frame, the distal end of the A-frame extends to an attached wheel hub. Wheels and tires engage upon and roll on the wheel hub during use and the handlebars are employed to steer the hubs.

As shown, each of the upper and lower A-frames on their engagement ends, at a forward located member, is in a pivoted engagement with the vehicle frame on the side opposite from the wheel hub and the wheel which the A-frame supports. This opposite side pivoting engagement provides each wheel hub engaging and supporting each wheel with four pivoting supports for each pair of two A-frames engaging the wheel to the frame. The pivoting engagement over centerline of the frame and pivoting arrangement of the hub member provides for a distance of travel of the wheel hub and wheel that far exceeds conventional frames which engage the A-frame members on the same side as the wheel they support.

The device employs a tubular frame having a center line in line with the handle bar support tube and running under the seat for the rider. Each front wheel hub is engaged to a pivoting hub member which is supported at the distal end of the upper and lower A-frames extending from the front of the vehicle. Each of the upper and lower A-frames supporting the hub member has a front support member engaged at a first end to a pivot on the opposite side of the center line than the wheel it supports.

A rear support member for the both the upper and lower A-frames is engaged on the same side of the frame as the wheel it supports and is in pivoted engagement to the vehicle frame at an angle to the center line such that it is substantially axially aligned with the connection to the hub member. This angled engagement serves to brace the front hub member from lateral forces encountered by the forward moving wheel which might bend the suspension if otherwise aligned. A spring is engaged at an angle between a frame mount and a cross member at the distal end of the lower A-frame. A shock absorber pivotally engaged between the frame and the lower A-frames mirrors the angle of the spring and provides dampening of movement of the impact absorbing spring subsequent to compression.

The front support members on both sides of the frame define the amount of travel possible by the wheel hubs engaged to the pivoting hub member at the distal ends of the upper and lower A-frames. The A-frame rear support members, as noted, provide bracing from impacts to the tires during rolling and landing such as when traversing ruts or rocks or landing from being airborne.

Since the front support members are both pivotally engaged on the opposite sides of the frame from the wheels they support, they are much longer and in a parallel relationship allowing them to rotate past each other, thereby increasing the travel of the wheel hub when the vehicle is airborne. Further, engaging the spring and pivoting shock absorber at an angle between an upper portion of the frame and lower A-frames also allows for a longer distance of travel of the spring and shock than a vertical engagement would allow since the shock will pivot during compression of the spring.

Using the longer front members, juxtaposed and supporting the wheel hubs and the angled pivoted engagement of the rear support members, the wheel hubs on the distal ends of the upper and lower A-frames achieve a significant increase in travel while concurrently achieving a significant increase in support from frontal impacts from the angled rear support members engaged on the same side as the wheel.

Each wheel is also supported by an upper A-frame also formed of a front and rear support member. The front support members of each of the upper A-frames pivotally engage an angled wheel hub support member at one end and are in pivoted engagement to the frame at an engagement end. The engagement ends of both upper front support members are also on the opposite sides of the center line of the frame from the wheels they support. Each upper A-frame also has a rear support member in an angled pivoted engagement to the frame on the same side as the wheel supported and pivotally engaged to the wheel hub support member. By engaging the rear support members on the same side as their respective wheel hub, the support members are substantially axially aligned between the frame and wheel hub and provide greater strength from frontal impacting forces than if they were located on the opposite side of the frame.

The results from this arrangement are two upper and two lower A-frame supports, pivotally engaged to a hub member with engaged hub, which securely hold the front wheels of the ATV and provide greatly increased travel of the hub engaged to their distal ends. Concurrently provided is a substantial increase in strength to resist forces impacting the front and sides of the wheels and tires. The angled springs and shock absorbers also provide more distance of travel to absorb the shock of landing from being airborne.

It is thus an object of this invention to provide a wheel hub support for the front steering axles of an ATV with greatly increased travel.

It is a further object of this invention to provide such a hub support which employs the increased travel with an engaged spring and shock absorber to thereby absorb more shock during landing of the vehicle from being airborne.

It is a further object of this invention to provide such a hub support that also provides rear support members to all A-frame supports which are angled relative to the hub along their axis to increase the strength of the hub to resist frontal forces impacting the wheel.

With respect to the above description and background, before explaining at least one preferred embodiment of the invention in detail, it is to be understood that the invention is not limited in its application to the details of construction and to the arrangement of the components and/or steps set forth in the following description or illustrated in the drawings. The various apparatus and methods of the invention herein described and disclosed are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other devices, methods and systems for carrying out the several purposes of the present disclosed device yielding increased travel and shock absorption on ATV front wheels. It is important, therefore, that the objects and claims be regarded as including such equivalent construction and methodology, insofar as they do not depart from the spirit and scope of the present invention.

### BRIEF DESCRIPTION OF DRAWINGS

FIG. 1 depicts a front perspective cut view of the dual A-frame wheel supports yielding increased hub travel and increased strength to resist frontal impact provided by the pivoted engagement on opposite sides of the frame of front members and rear members pivoted to the same side of the frame.

### DETAILED DESCRIPTION OF PREFERRED EMBODIMENTS

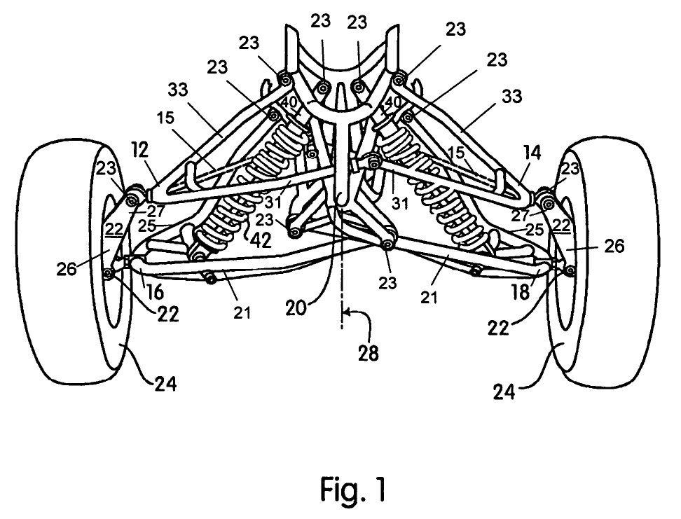

The drawing in FIG. 1 depicts the ATV having the disclosed improved front steerable suspension system herein. The suspension for the front of the ATV features two upper A-frames 12 and 14 and two lower A-Frames 16 and 18, each in a pivoted engagement to the frame 20 at two points on their respective first end. Each of the A-frames extends to an engagement at a distal end with a wheel hub member 22 that is adapted to rotationally support an ATV wheel 24 and tire on the steering axle of the ATV. Such rotational engagement of wheels 24 is well known in the art and conventionally employs a steering-rotatable projecting spindle on which the wheel 24 rotates. The spindle-engaged wheels 24 are steerable by steering rods 15 engaged to the handlebars (not shown).

As shown, on each side of the ATV a respective upper A-Frame 12 and 14 is paired with a respective lower A-frame 16 and 18 to form two steerable wheel suspensions for the ATV wheels 24. The hub members 22 are pivotally engaged 23 at a first end with the distal ends of the upper A-frames 12 and 14 and at a second end 26 opposite the first end 27, with the lower A-frames 16 and 18 respectively. The center line for the wheel 24 provided by the spindle mount is adjacent to the second end 26 where the spindle projects substantially perpendicular to the centerline 28.

The pivotal engagement 23 of the hub member 22 allows for the engaged pairs of upper and lower A-frames to travel when airborne or traversing bumps and ruts and maintain the wheels substantially parallel to the centerline 28. This means to maintain the wheels 24 perpendicular is provided by the hub member 22 being engaged to the spindle adjacent to the second end 26, and the placement of the first end 27 closer to the centerline 28 by the angled positioning of the hub member 22. In use, as the lower A-frame descends to traverse ruts or should the vehicle become airborne, the rotation of the upper A-frame in its pivoted engagement 23 to the first end 27 of the hub member 22, will concurrently rotate the hub member 22 at the pivoted engagement 23 to the lower A-frame, and thereby maintain the wheels 24 substantially parallel to the center line 28 by rotating the angles of the projecting spindles supporting the wheels 24.

Each lower A-frame 16 and 18 has a front support member 21 which is in a pivoted engagement 23 with the vehicle frame 20 on the side opposite from the wheel hub member 22 which that respective lower A-frame front supports. The two lower A-frame front support members 21, travel in adjacent side-by-side pathways with each other by the placement of their respective pivoting engagement 23 to the frame 20 in adjacent rather than inline positions on the frame 20. As noted, this opposite side pivoting engagement 23, combined with the adjacent paths followed by the front support members 21, allows for increased travel of the hub member 22 supporting the spindle and the wheel 24 engaged thereto.

Each lower A-frame has a rear support member 25 which is in a pivotal engagement 23 on the same side of the frame 20 as the respective wheel 24 it supports. This is a most preferred mode as it angles the rear support members 25 from the center line 28 to place them axially substantially inline between their engagement to the frame 20 and to the hub member 22 supporting the wheel 24, and at a downward angle from the frame 20 toward the wheel 24. This angled downward positioning places the tubes forming the rear support members 25 substantially axially disposed in relation to the position of the wheel 24 they support, and thus in their strongest position to resist frontal impacts to the wheels 24 transmitted to the hub members 22. The downward angling of the support members 25 also allows them to continue to be aligned axially between their engagement to the frame 20 and hub member 22 during upward wheel travel to traverse bumps or downward wheel travel when airborne or traversing ruts.

Each upper A-frame 12 and 14 has a front support member 31 which is in a pivoted engagement 23 with the vehicle frame 20 which is also positioned on the side opposite from the wheel 24 which that respective upper A-frame supports. This opposite side pivoting engagement 23 works in concert with that of the lower A-frame and as noted allows for increased travel of the hub member 22 and spindle engaging the wheel 24 adjacent to the distal end of the lower A-frame engagement to the hub member 22.

Each upper A-frame 12 and 14 also has a rear support member 33 which is in a pivotal engagement 23 on the same side of the frame 20 as the hub member 22 and wheel 24 it supports in the same fashion as the upper A-frame to which it is paired. As noted this is most preferred as it angles the rear support members 33 from center line 28 to place them substantially axially inline between the frame 20 and hub member 22 and wheel 24. Also, similar to those rear support members 25 of the lower upper A-frame, these rear support members 33 are pivotally engaged 23 at a downward angle from their engagement with the frame 20 toward the hub member 22 and wheel 24 they support. Thus each pair of A-frames, has rear support members 25 and 33 positioned in their strongest position relative to the wheel 24 from the frame 20, to resist frontal impacts to the wheels on the suspension. The downward angling of both rear support members 25 and 33 also allows them to act in concert while pivotally connected to the hub members 22 to both maintain the wheels substantially parallel to the center line 28, by acting to pivot the hub member 22 while concurrently providing increased resistance to frontal impact forces on the wheel 24 during the entire travel distance of the suspension.

Also as noted earlier, a spring 40 is engaged coaxially around the shock 42 and at an angle between a frame 20 and the distal end of the lower A-frames 12 and 14. The shock absorbers 42 being coaxially engaged thereby mirror the angle of the spring 40 and provide dampening of movement of the compressed spring 40 after a landing. The spring 40 may be fixedly engaged at both ends of the spring 40 to the shock 42, to thereby also resist downward wheel travel too quickly when the vehicle becomes airborne and the wheels 24 drop from lack of land support.

Thus, each wheel hub 22 and spindle-engaged wheel 24 is operatively connected with the frame 20, by paired upper and lower A-frames in their pivoting engagements 23. Travel distance of each wheel 24 is maximized by the engagement of the front members 21 and 31 of the A-frames in pivoting engagements 23, upon the opposite side from the center line 28 of the frame 20, as the wheel 24 they support.

Strength to resist frontal impacts and forward rolling of the wheel 24 is maximized by the substantially axial positioning of the respective rear support members 25 and 33 on each side. The pivoting engagement 23 of the hub members 22 and angled positioning of the hub members 22 toward the upper end of the frame 20, from the pivoting engagement 23 at the lower or second end 26 of the hub members 22, maintain the wheels 24 substantially parallel with the center line 28 during all phases of travel of the suspension. This increased travel of the paired A-frames thereby allows for increased compression or expansion of the springs 40, and longer springs 40 and spring dampeners in the form of shocks 42 to be employed, to thereby absorb the shock of the wheels 24 landing or impacting bumps and ruts.

With regard to the forgoing, it is to be understood that elements of different construction and configuration and different steps and process procedures and other arrangements thereof, other than those illustrated and described may be employed for providing the ATV front suspension and steering axle, and any method herein, within the spirit of this invention.

As such, while the present invention has been described herein with reference to particular embodiments thereof, a latitude of modifications, various changes and substitutions are intended in the foregoing disclosure, and it will be appreciated that in some instance some features of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

What is claimed is:

1. A steerable ATV suspension for supporting wheels engaged to spindles at the distal ends of said suspension, comprising:
a vehicle frame having a front and rear hand having centerline running therebetween and having two sides;
two A-frame supports, one each of said A-frame supports having a pivotal engagement to said frame at a first end on a respective of said two sides, each said A-frame supports extending from said first end, to a second end;
each said A-frame support comprising:
an upper A-frame having a front support member and a rear support member both extending from said first end to a upper connection of their respective distal ends;
a lower A-frame having a front support member and rear support member both extending from said first end to a lower connection of their respective distal ends;
a spindle member defining said second end of said A-frame support, said spindle rotationally engaged at a first engagement with said lower connection and at a second engagement with said upper connection, said spindle member adapted to support said steerable spindle for said wheel;
said pivotal engagement of said front support member of said upper A-frame and said lower A-frame being at pivot positions on said frame, said pivot positions being adjacent to said front of said frame and on a side of said frame opposite the respective position the said A-frame support they connect to said frame; and
said pivot positions on said frame being juxtaposed along said center line.

2. The steerable ATV suspension of claim 1 additionally comprising:
a shock absorber pivotally engaged at a first end to said frame and at a second end to said adjacent to said lower connection of said lower A-frame; and
a spring coaxially engaged around said shock absorber.

3. The steerable ATV suspension of claim 1 additionally comprising:
said rear support members of both said upper A-frame and said lower A-frame engaged to said frame at a positions along said center line spaced rearward from said juxtaposed pivot positions, said rear support members extending at acute angles from said center line and substantially axially aligned between said frame and said spindle member.

4. The steerable ATV suspension of claim 2 additionally comprising:
said rear support members of both said upper A-frame and said lower A-frame engaged to said frame at a positions along said center line spaced rearward from said juxtaposed pivot positions, said rear support members extending at acute angles from said center line and substantially axially aligned between said frame and said spindle member.

5. The steerable ATV suspension of claim 1 additionally comprising:
said lower connection distanced from said center line a distance further than said upper connection;
said spindle member extending at a spindle angle from said first engagement to said second engagement; and
said upper connection pivoting concurrently with said lower section during a use of said ATV suspension, thereby causing an adjustment in said spindle angle, said adjustment thereby providing means to maintain said wheels substantially parallel to each other and perpendicular to a road surface.

6. The steerable ATV suspension of claim 2 additionally comprising:
said lower connection distanced from said center line a distance further than said upper connection;
said spindle member extending at a spindle angle from said first engagement to said second engagement; and
said upper connection pivoting concurrently with said lower section during a use of said ATV suspension, thereby causing an adjustment in said spindle angle, said adjustment thereby providing means to maintain said wheels substantially parallel to each other and perpendicular to a road surface.

7. The steerable ATV suspension of claim 3 additionally comprising:
said lower connection distanced from said center line a distance further than said upper connection;
said spindle member extending at a spindle angle from said first engagement to said second engagement; and
said upper connection pivoting concurrently with said lower section during a use of said ATV suspension, thereby causing an adjustment in said spindle angle, said adjustment thereby providing means to maintain said wheels substantially parallel to each other and perpendicular to a road surface.

8. The steerable ATV suspension of claim 4 additionally comprising:
said lower connection distanced from said center line a distance further than said upper connection;
said spindle member extending at a spindle angle from said first engagement to said second engagement; and
said upper connection pivoting concurrently with said lower section during a use of said ATV suspension, thereby causing an adjustment in said spindle angle, said adjustment thereby providing means to maintain said wheels substantially parallel to each other and perpendicular to a road surface.

9. The steerable ATV suspension of claim 1 additionally comprising:
said pivot juxtaposed positions on said frame providing adjacent pathways for rotation of said front support members of both said upper A-frames and both of said lower A-frames whereby said pathways for said front support members traverse each other.

10. The steerable ATV suspension of claim 2 additionally comprising:
said pivot juxtaposed positions on said frame providing adjacent pathways for rotation of said front support members of both said upper A-frames and both of said lower A-frames whereby said pathways for said upper front support members and said lower support members respectively traverse each other.

11. The steerable ATV suspension of claim 3 additionally comprising:
said pivot juxtaposed positions on said frame providing adjacent pathways for rotation of said front support members of both said upper A-frames and both of said lower A-frames whereby said pathways for said upper front support members and said lower support members respectively traverse each other.

12. The steerable ATV suspension of claim 4 additionally comprising:
said pivot juxtaposed positions on said frame providing adjacent pathways for rotation of said front support members of both said upper A-frames and both of said lower A-frames whereby said pathways for said upper front support members and said lower support members respectively traverse each other.

13. The steerable ATV suspension of claim 5 additionally comprising:
said pivot juxtaposed positions on said frame providing adjacent pathways for rotation of said front support members of both said upper A-frames and both of said lower A-frames whereby said pathways for said upper front support members and said lower support members respectively traverse each other.

14. The steerable ATV suspension of claim 6 additionally comprising:
said pivot juxtaposed positions on said frame providing adjacent pathways for rotation of said front support members of both said upper A-frames and both of said lower A-frames whereby said pathways for said upper front support members and said lower support members respectively traverse each other.

15. The steerable ATV suspension of claim 7 additionally comprising:
said pivot juxtaposed positions on said frame providing adjacent pathways for rotation of said front support members of both said upper A-frames and both of said lower A-frames whereby said pathways for said upper front support members and said lower support members respectively traverse each other.

16. The steerable ATV suspension of claim 8 additionally comprising:
said pivot juxtaposed positions on said frame providing adjacent pathways for rotation of said front support members of both said upper A-frames and both of said lower A-frames whereby said pathways for said upper front support members and said lower support members respectively traverse each other.
